(19) United States
(12) Patent Application Publication
(10) Pub. No.: US 2024/0319980 A1
(43) Pub. Date: Sep. 26, 2024

(54) VEHICLE

(71) Applicant: TOYOTA JIDOSHA KABUSHIKI KAISHA, Toyota-shi (JP)

(72) Inventors: Tomoaki MIYAZAWA, Nagoya-shi (JP); Ryota Nakabayashi, Nagoya-shi (JP); Naoki Ymoda, Toyota-shi (JP); Atsushi Mori, Miyoshi-shi (JP); Hiroshi Inoue, Nagoya-shi (JP); Tsukasa Kitazawa, Toyota-shi (JP)

(73) Assignee: TOYOTA JIDOSHA KABUSHIKI KAISHA, Toyota-shi (JP)

(21) Appl. No.: 18/432,597

(22) Filed: Feb. 5, 2024

(30) Foreign Application Priority Data
Mar. 20, 2023 (JP) 2023-043963

(51) Int. Cl. G06F 8/65; G07C 5/00; H04W 84/12

(52) U.S. Cl. CPC G06F 8/65; G07C 5/008; H04W 84/12

(57) ABSTRACT

A vehicle configured to obtain update data via a wireless LAN and updates software of an in-vehicle device using the update data includes one or more processors. The one or more processors are configured to determine whether an update of the software is in an executable state in a situation where the update of the software is requested and the vehicle is located in a position where the vehicle is connectable to the wireless LAN. The one or more processors are configured to connect the vehicle to the wireless LAN on a condition that the one or more processors determine that the update of the software is in the executable state.

### CROSS-REFERENCE TO RELATED APPLICATION

This application claims priority to Japanese Patent Application No. 2023-043963 filed on Mar. 20, 2023 incorporated herein by reference in its entirety.

### BACKGROUND

### 1. Technical Field

The present disclosure relates to a vehicle that updates software by obtaining update data via a wireless local area network (LAN).

### 2. Description of Related Art

Japanese Unexamined Patent Application Publication No. 2011-521549 (JP 2011-521549 A) describes a mobile device that performs automatic connection to a wireless LAN when the device is located at a connection point of a pre-designated wireless LAN, as a mobile device such as a smartphone.

### SUMMARY

In a vehicle that connects to a wireless LAN to download software update data, it may be possible to automatically connect the vehicle to the wireless LAN when the vehicle is located at a wireless LAN connection point. The vehicle consumes electric power when connecting to the wireless LAN. Therefore, when the connection is performed to the wireless LAN every time the vehicle is located at the connection point, amount of electric power consumption of the vehicle increases.

In a first aspect of the present disclosure, a vehicle configured to obtain update data via a wireless local area network (LAN) and updates software of an in-vehicle device using the update data includes one or more processors. The one or more processors are configured to determine whether an update of the software is in an executable state in a situation where the update of the software is requested and the vehicle is located in a position where the vehicle is connectable to the wireless LAN. The one or more processors are configured to connect the vehicle to the wireless LAN on a condition that the one or more processors determine that the update of the software is in the executable state.

In the vehicle according to the first aspect of the present disclosure, the one or more processors may be configured to connect the vehicle to the wireless LAN in a situation where the vehicle is located in a position where the vehicle is connectable to the wireless LAN, regardless of whether the one or more processors determine that the update oh the software is in the executable state, in a case when the update of the software is not requested.

In the vehicle according to the first aspect of the present disclosure, in a case where a category of the software for which an update is requested is a predetermined category, the one or more processors may be configured to connect the vehicle to the wireless LAN in a situation where the vehicle is located in a position where the vehicle is connectable to the wireless LAN, regardless of whether the one or more processors determine that the update of the software is in the executable state.

The vehicle controls the connection to the wireless LAN in accordance with the determination result of whether the update of the software is in the executable state, so that the electric power consumption of the vehicle can be suppressed.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram schematically showing a configuration of an embodiment of a vehicle; and

FIG. 2 is a flowchart of a connection control routine executed in the vehicle.

### DETAILED DESCRIPTION OF EMBODIMENTS

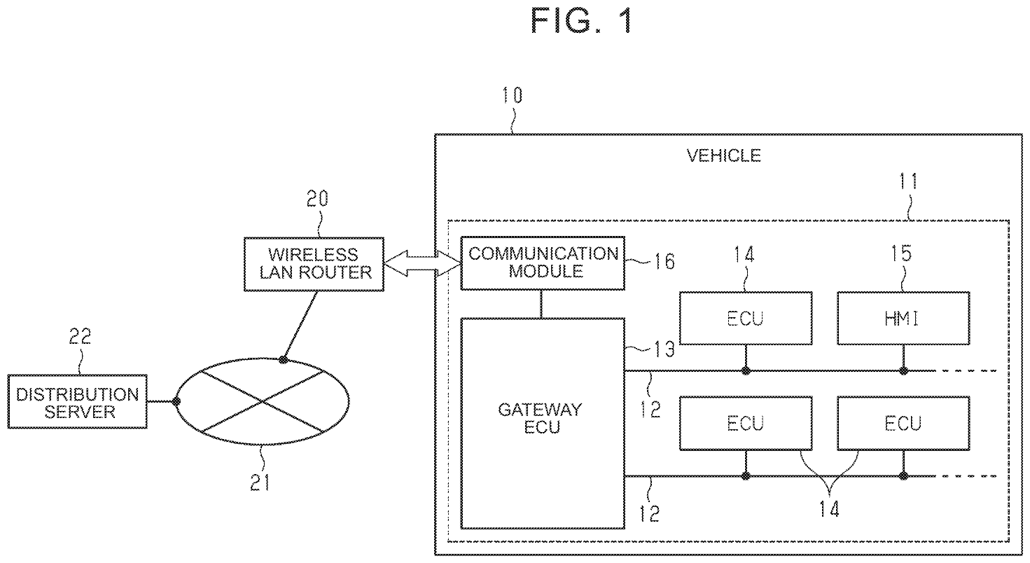

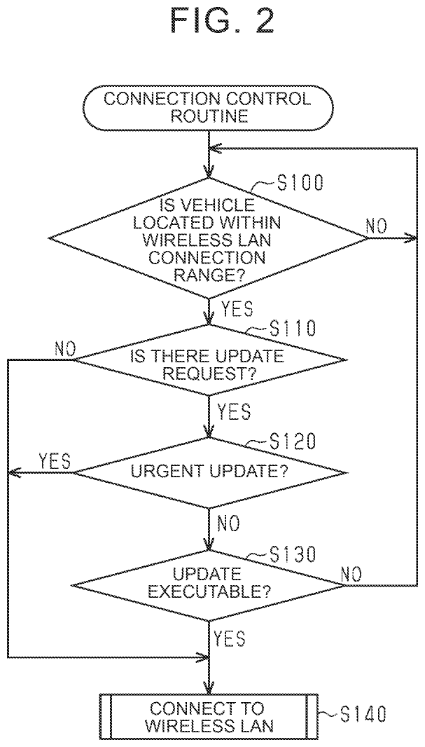

Hereinafter, an embodiment of a vehicle will be described in detail with reference to FIGS. 1 and 2.

### Configuration of Vehicle

First, a configuration of a vehicle 10 according to the present embodiment will be described with reference to FIG. 1. The vehicle 10 includes an in-vehicle network 11. The in-vehicle network 11 is configured by a plurality of in-vehicle devices that is connected to a communication line 12. The in-vehicle device that constitutes the in-vehicle network 11 is an in-vehicle electronic device that includes a communication function. Each in-vehicle device has a processor and a memory. Also, each in-vehicle device is configured to operate when a processor executes a program stored in the memory. Each in-vehicle device may include one or more processors. Each in-vehicle device may include one or more memories.

The vehicle 10 includes a gateway ECU 13 as one of the in-vehicle devices that constitute the in-vehicle network 11. The gateway ECU 13 is an electronic control unit (ECU) that relays communication between the in-vehicle devices via the communication line 12 and between the in-vehicle device and the outside of the vehicle.

The in-vehicle device that constitutes the in-vehicle network 11 includes an ECU 14 other than the gateway ECU 13 and an HMI 15. An example of the ECU 14 includes an ECU for engine control, an ECU for shift control, an ECU for brake control, and an ECU for advanced driver assistance systems. The HMI 15 is a human machine interface. The HMI 15 includes an input device such as a touch panel, and an output device that outputs images and sounds. Other examples of the in-vehicle device that constitutes the in-vehicle network 11 include an in-vehicle entertainment system and a sensor. Such a vehicle 10 is configured to be able to update software of the in-vehicle device.

A communication module 16 is connected to the gateway ECU 13. The communication module 16 performs wireless communication with a wireless local area network (LAN) router 20 installed outside the vehicle. The wireless LAN router 20 has an access point function and a router function. When the communication module 16 is connected to the wireless LAN router 20, the gateway ECU 13 is connected to an internet 21 via the communication module 16 and the wireless LAN router 20.

A distribution server 22 is connected to the internet 21. The distribution server 22 is a server device that distributes a software update guide and software update data of the in-vehicle device to each vehicle 10.

### Update of Software

Next, the update of the software of the in-vehicle device in the vehicle 10 will be described.

When the software is updated, the distribution server 22 distributes update guide information to each vehicle 10. The guide information includes information such as text data of update content, an amount of the update data, and a time to start distributing the update data. When the gateway ECU 13 of each vehicle 10 receives the guide information, the gateway ECU 13 causes the HMI 15 to display a guide screen. The guide screen displays a text of the update data, a button for selecting whether the update is necessary, and the like. When a user has accepted the update and when the distribution server 22 has started distributing the update data, the gateway ECU 13 determines that the update of the software is requested.

When the update of the software is requested and when the vehicle 10 is connected to the wireless LAN, the gateway ECU 13 downloads the update data from the distribution server 22 and stores the downloaded update data in a data storage of the gateway ECU 13. The update data may include any of an update software, compressed data obtained by compressing the update software, divided data obtained by dividing the update software or the compressed data, and difference data indicating a difference between the software before the update and the software after the update. Further, the update data may include an identifier of the in-vehicle electronic device to be updated and an identifier of the software before the update. The update data is downloaded as a distribution package. The distribution package includes the update data for one or more in-vehicle electronic devices.

After completing the download of the update data, the gateway ECU 13 performs installation of the update software. Specifically, the gateway ECU 13 writes the update software into the memory of the in-vehicle device to be updated. When the update data includes the update software itself, the gateway ECU 13 performs the installation by transferring the update data to the in-vehicle device to be updated. When the update data includes the compressed data, the difference data, or the divided data of the update software, a generating process of the update software from the update data is performed. The generating process may be performed by the gateway ECU 13 or by the in-vehicle device to be updated. The update software can be generated by decompressing the compressed data and assembling the difference data or the divided data.

After the installation is complete, the in-vehicle device to be updated performs an activation. When the activation is performing, the in-vehicle device performs a consistency check on the update software version and the like. After the consistency check, the in-vehicle device is switched from a state in which the in-vehicle device operates with the software before the update to a state in which the in-vehicle device operates with the software after the update.

The vehicle 10 according to the present embodiment is configured to download the update data via the wireless LAN. Therefore, when the update of the software is requested and the vehicle 10 is connected to the wireless LAN, the gateway ECU 13 starts downloading the update data. Additionally, the installation and the activation of the update software is performed at a time determined by the category of the in-vehicle device and the software. For example, in a case of the ECU 14 that performs control relating to traveling of the vehicle 10, the installation is performed after an ignition switch is turned off and the activation is performed after the ignition switch is turned on next time.

### Wireless LAN Connection Control

Next, with reference to FIG. 2, the control of the gateway ECU 13 related to the connection of the vehicle 10 to the wireless LAN will be described. FIG. 2 shows a flowchart of a wireless LAN connection control routine that is executed by the gateway ECU 15 13.

When the vehicle 10 is not connected to the wireless LAN, the gateway ECU 13 performs determination on whether the vehicle 10 is located within a wireless LAN connection range (S100). The wireless LAN connection range is a range of a position of the vehicle 10 that is connectable to the pre-designated wireless LAN router 20. Whether the 20 vehicle 10 is located within a communication range can be determined by, for example, whether the communication module 16 has received a signal from the pre-designated wireless LAN router 20. Further, the same determination can be performed by specifying the position of the vehicle 10 from a global positioning system (GPS) signal and by determining 25 whether the position is within the connection range of the pre-designated wireless LAN. When the vehicle 10 is not located within the wireless LAN connection range (S100: NO), the gateway ECU 13 performs the determination in step S100 again after a predetermined control cycle has elapsed.

When the vehicle 10 is located within the wireless LAN connection range (S100: YES), the gateway ECU 13 determines whether there is a request for the update of the software in step S110. When there is no request for the update of the software (S110: NO), the gateway ECU 13 instructs the communication module 16 to connect to the wireless LAN router 20 in order to connect the vehicle 10 to the wireless LAN in step S140.

In contrast, when there is a request for the update of the software (S110: YES), the gateway ECU 13 determines whether the category of the software for which the update is requested is a category that corresponds to an urgent update in step S120. Some software needs to be updated with a high urgency. The gateway ECU 13 determines, based on information on the category of the software that is included in the guide information obtained from the distribution server 22, whether the urgent update is necessary. Then, when the software for which the update is requested requires the urgent update (the category of the software for which the update is requested is a category that corresponds to the urgent update) (S120: YES), the gateway ECU 13 instructs to connect the vehicle 10 to the wireless LAN in step S140.

When the category of the software to be updated is not a category that requires the urgent update (S120: NO), the gateway ECU 13 advances the process to step S130. Then, in step S130, the gateway ECU 13 determines whether the update of the software is in an executable state. The gateway ECU 13 determines that the update of the software is in the executable state when both of the following requirements (A) and (B) are satisfied.

The requirement (A) is that when downloading the update data is started by connecting with the wireless LAN, there is a low possibility that the vehicle 10 moves out of the communication range of the wireless LAN before the download is completed such that the download will be interrupted. The gateway ECU 13 determines that the requirement (A) is satisfied, for example, when the ignition switch of the vehicle 10 is turned off. Even when the vehicle 10 is stopped, there is a possibility that the user may resume traveling while the ignition switch is on.

The requirement (B) is that an execution condition for installing and activating the update software is satisfied. The execution condition for installing and activating the update software is set for each category of the in-vehicle device and the software. When these execution conditions are not satisfied, the update of the software cannot be completed even when the update data is downloaded. For example, the in-vehicle device to be updated may continue to operate even after the vehicle 10 has stopped. The installation and the activation of the update software cannot be executed while the operation continues. Therefore, the execution condition for installing and activating the update software is satisfied until the in-vehicle device to be updated can stop its operation.

Then, when the gateway ECU 13 determines that the update of the software is in the executable state (S130: YES), the gateway ECU 13 advances the process to step S140 and performs the connection to the wireless LAN. In contrast, when the gateway ECU 13 determines that the update of the software is not in the executable state (S130: NO), the gateway ECU 13 puts the connection of the vehicle 10 to the wireless LAN on hold. Specifically, the gateway ECU 13 in this case returns the process to step S100 after the predetermined control cycle has elapsed.

### Actions and Effects of Embodiment

The gateway ECU 13 in the vehicle 10 according to the present embodiment determines whether the update of the software is in the executable state when the update of the software is requested and the vehicle 10 is located in the position where the vehicle 10 is connectable to the wireless LAN. Then, the gateway ECU 13 connects the vehicle 10 to the wireless LAN on a condition that the gateway ECU 13 determines that the update of the software is in the executable state. The vehicle 10 obtains the update data via the wireless LAN and updates the software of the in-vehicle device based on the update data.

In contrast, when the gateway ECU 13 determines, in the above determination, that the update of the software is not in the executable state, the gateway ECU 13 puts the connection of the vehicle 10 to the wireless LAN on hold. In this case, even when the vehicle 10 is connected to the wireless LAN and downloading the update data is started, there is a high possibility that the update of the software cannot be completed. In the vehicle 10 according to the present embodiment, when there is a high possibility that the update of the software cannot be completed, the connection to the wireless LAN is put on hold.

According to the vehicle 10 of the present embodiment described above, the following effects can be achieved.
(1) The gateway ECU 13 in the vehicle 10 according to the present embodiment determines whether the update of the software is in the executable state when the update of the software is requested and the vehicle 10 is located in the position where the vehicle 10 is connectable to the wireless LAN. Then, the gateway ECU 13 connects the vehicle 10 to the wireless LAN on a condition that the gateway ECU 13 determines that the update of the software is in the executable state. Therefore, chances of the vehicle 10 being unnecessarily connected to the wireless LAN although the update of the software cannot be completed are reduced. Therefore, the vehicle 10 according to the present embodiment has an effect of suppressing electric power consumption for connecting to the wireless LAN.
(2) Immediately after the distribution server 22 starts distributing the update data, downloads of the update data by each vehicle 10 are concentrated and a load on the distribution server 22 tends to increase. In the present embodiment, downloading the update data is postponed for the vehicle 10 in which the update of the software is not currently in the executable state. As a result, downloading the update data is distributed, so that the load on the distribution server 22 can be reduced.
(3) When the update of the software is not requested, the gateway ECU 13 connects the vehicle 10 to the wireless LAN when the vehicle 10 is located in the position where the vehicle 10 is connectable to the wireless LAN. That is, the gateway ECU 13 in this case connects the vehicle 10 to the wireless LAN regardless of whether the update of the software is in the executable state. Therefore, it becomes easier for the vehicle 10 to quickly obtain the guide information of the update of the software distributed by the distribution server 22.
(4) In a case where the category of the software for which the update is requested is the category that requires the urgent update, the gateway ECU 13 connects the vehicle 10 to the wireless LAN when the vehicle 10 is located in the position where the vehicle 10 is connectable to the wireless LAN. That is, the gateway ECU 13 in this case connects the vehicle 10 to the wireless LAN regardless of whether the update of the software is in the executable state. Even when the update of the software is determined not to be in the executable state, the possibility that the update can be completed may not be zero. Furthermore, even when the update is not completed, it may be possible to complete part of the update process. Therefore, there is a high possibility that the update of the software with a high urgency can be performed at an early stage.

### Correspondence

In the vehicle 10 according to the present embodiment, the gateway ECU 13 is an example of a determination unit that determines whether the update of the software is in the executable state, when the update of the software is requested and the vehicle 10 is located in the position where the vehicle 10 is connectable to the wireless LAN. Furthermore, in the vehicle 10 according to the present embodiment, the gateway ECU 13 is also an example of a connection unit that connects the vehicle 10 to the wireless LAN on the condition that the determination unit determines that the update of the software is in the executable state.

### OTHER EMBODIMENTS

The present embodiment can be realized with the following modifications. The present embodiment and the following modifications can be combined with each other within a technically consistent range to be realized.

### Determination in Step S130 in FIG. 2

The determination in step S130 in FIG. 2 may be performed based on the premise that the requirement (A) is satisfied in the following cases.
The vehicle 10 is stopped. Even when the vehicle 10 is within the wireless LAN connection range, there is a possibility that the vehicle 10 will subsequently move out of the connection range when the vehicle 10 is moving. Therefore, it is desirable to put the connection to the wireless LAN on hold until the vehicle 10 is confirmed to have stopped.
The vehicle 10 is parked. Even when the vehicle 10 has stopped within the wireless LAN connection range, the vehicle 10 may resume traveling after that. Therefore, it is desirable to put the connection to the wireless LAN on hold until the vehicle 10 is confirmed to have been parked by operating a shift lever to a parking position or activating a parking brake operation.
A hazard lamp is not lit. When a driver temporarily stops the vehicle 10 on a roadside and the like, the driver may turn on the hazard lamp. Therefore, when the hazard lamp is turned on, there is a high possibility that the vehicle 10 will resume traveling after that, so it is desirable to put the connection to the wireless LAN on hold.
No doors are open. Even when the vehicle 10 is stopped, there is a possibility that an occupant will re-board the vehicle 10 and the vehicle 10 will resume traveling, when the door remains open. Therefore, when there is an open door, it is desirable to put the connection to the wireless LAN on hold.

### Others

For the connection control, whether the vehicle 10 needs to be connected to the wireless LAN may be determined regardless of the category of the software to be updated. That is, the determination process in step S120 in FIG. 2 may be omitted.
An immediate connection of the vehicle 10 to the wireless LAN may be required regardless of the update of the software. In such a case, it is desirable to connect the vehicle 10 to the wireless LAN as soon as the connection becomes possible. Therefore, in the connection control, when the gateway ECU 13 has received a predetermined urgent notification, the gateway ECU 13 may be configured to connect the vehicle 10 to the wireless LAN at a time when the vehicle 10 enters the connection range.
The communication module 16 and the distribution server 22 may be configured to include a connection function to a mobile communication network. In this case as well, when the vehicle 10 obtains the update data via the wireless LAN, the electric power consumption can be suppressed by employing the connection control according to the above embodiment.
The vehicle 10 may be configured such that the in-vehicle device other than the gateway ECU 13 performs the connection control. Also, separate in-vehicle devices may perform the determination on whether the connection to the wireless LAN is necessary and the connection to the wireless LAN based on the determination result.

### APPENDIXES

### Appendix 1

A vehicle configured to obtain update data via a wireless LAN and updates software of an in-vehicle device using the update data, the vehicle including: a determination unit that determines whether an update of the software is in an executable state in a situation the update of the software is requested and the vehicle is located in a position where the vehicle is connectable to the wireless LAN; and a connection unit that connects the vehicle to the wireless LAN on a condition that the determination unit determines that the update of the software is in the executable state.

### Appendix 2

The vehicle according to appendix 1, wherein the connection unit connects the vehicle to the wireless LAN in a situation the vehicle is located in the position where the vehicle is connectable to the wireless LAN, regardless of whether the determination unit determines that the update of the software is in the executable state, in a case when the update of the software is not requested.

### Appendix 3

The vehicle according to appendix 1 or 2, wherein in a case where a category of the software for which an update is requested is a predetermined category, the connection unit connects the vehicle to the wireless LAN in a situation the vehicle is located in the position where the vehicle is connectable to the wireless LAN, regardless of whether the determination unit determines that the update of the software is in the executable state.

### Appendix 4

The vehicle according to any one of appendixes 1 to 3, wherein the determination unit determines that the update of the software is in the executable state on a condition that an ignition switch is turned off.

### Appendix 5

The vehicle according to any one of appendixes 1 to 4, wherein the determination unit determines that the update of the software is in the executable state on a condition that the vehicle is stopped.

### Appendix 6

The vehicle according to any one of appendixes 1 to 5, wherein the determination unit determines that the update of the software is in the executable state on a condition that the vehicle is parked.

### Appendix 7

The vehicle according to any one of appendixes 1 to 6, wherein the determination unit determines that the update of the software is in the executable state on a condition that the hazard lamp is not lit.

### Appendix 8

The vehicle according to any one of appendixes 1 to 7, wherein the determination unit determines that the update of the software is in the executable state on a condition that there is no open door.

### Appendix 9

The vehicle according to any one of appendixes 1 to 8, wherein the connection unit connects the vehicle to the wireless LAN when a predetermined urgent notification has been received, regardless of a determination result of the determination unit.

What is claimed is:

1. A vehicle configured to obtain update data via a wireless local area network (LAN) and updates software of an in-vehicle device using the update data, the vehicle comprising one or more processors configured to:
determine whether an update of the software is in an executable state in a situation where the update of the software is requested and the vehicle is located in a position where the vehicle is connectable to the wireless LAN; and
connect the vehicle to the wireless LAN on a condition that the one or more processors determine that the update of the software is in the executable state.

2. The vehicle according to claim 1, wherein the one or more processors are configured to connect the vehicle to the wireless LAN in a situation where the vehicle is located in a position where the vehicle is connectable to the wireless LAN, regardless of whether the one or more processors determine that the update of the software is in the executable state, in a case where the update of the software is not requested.

3. The vehicle according to claim 1, wherein in a case where a category of the software for which an update is requested is a predetermined category, the one or more processors are configured to connect the vehicle to the wireless LAN in a situation where the vehicle is located in a position where the vehicle is connectable to the wireless LAN, regardless of whether the one or more processors determine that the update of the software is in the executable state.
